(19) United States
(12) Patent Application Publication
(10) Pub. No.: US 2023/0130459 A1
(43) Pub. Date: Apr. 27, 2023

(54) CONTROL DEVICE FOR MACHINE TOOL

(71) Applicant: OKUMA CORPORATION, Niwa-Gun (JP)

(72) Inventor: Eisuke SOGABE, Niwa-Gun (JP)

(73) Assignee: OKUMA CORPORATION, Niwa-Gun (JP)

(21) Appl. No.: 17/938,379

(22) Filed: Oct. 6, 2022

(30) Foreign Application Priority Data
Oct. 26, 2021 (JP) 2021-174886

(51) Int. Cl. B23G 1/44; B23G 5/06

(52) U.S. Cl. CPC B23G 1/44; B23G 5/062

(57) ABSTRACT

A control device for a machine tool in which a tool used to machine a workpiece is mounted to a main spindle that is relatively movable with respect to the workpiece. The control device includes: a parameter preparing unit that stores a predetermined parameter regarding a control in advance; an evacuation unit that causes the tool to perform an evacuation operation from the workpiece; and a chip discharging unit that causes the tool to perform a chip discharging operation. The evacuation operation of the tool by the evacuation unit and the chip discharging operation by the chip discharging unit are performable at respective predetermined timings.

### CROSS REFERENCE TO RELATED APPLICATION

This application claims the benefit of Japanese Patent Application Number 2021-174886 filed on Oct. 26, 2021, the entirety of which is incorporated by reference.

### FIELD OF THE INVENTION

The present disclosure relates to a control device that causes a tool to evacuate safely and automatically without breakage when a machining failure or the like occurs in a machine tool.

### BACKGROUND OF THE INVENTION

In a machine tool, when performing a screw machining using a tap as a tool, in a case where a failure occurs during the machining, a procedure of extracting the tap from a screw hole in the middle of the machining is necessary. In a case where the extraction operation is performed automatically by a machine, when chips are bitten between a cutting edge and a created screw surface, the tap receives a large load. In the worst case, breakage occurs and the workpiece becomes defective. Therefore, in the current situation, a human performs the extraction operation by hand while adjusting the load during the operation, thus requiring many man-hours before resuming the machining and degrading productivity. Accordingly, a method of controlling an evacuation speed upon evacuation based on tap information and workpiece information is proposed.

For example, JP 1994-59715 A discloses automatizing the extraction operation without causing damage to the tap or the workpiece by calculating a main spindle speed of the extraction operation using tap pitch information and workpiece material information as input and evacuating the tool at the calculated speed.

JP 1994-59715 A described above proposes a technique of determining in advance the main spindle speed of the extraction operation at which breakage does not occur for each workpiece material, and evacuating the tool at the speed calculated based on the main spindle speed determined using the workpiece material information as input and the tap pitch information. However, depending on a biting status of the chips between the cutting edge and the created screw surface when the machining is interrupted, simply performing a reverse operation causes the tap to receive a large load and makes it difficult to avoid breakage. FIG. 1A shows an operational torque in a case where biting of the chips is little upon evacuation in the tap machining. FIG. 1B shows an operational torque in a case where biting of the chips is large upon evacuation in the tap machining. In the case where the biting is little, evacuation is completed without breakage, but in the case where the biting is large, vibration occurs in the operational torque immediately before the machining interruption, thus causing a tool breakage after performing the reverse operation to evacuate. Accordingly, with the conventional invention, in the worst case, breakage occurs and the workpiece becomes defective. Alternatively, extraction is performed by a human hand and thus degrades productivity.

Therefore, it is an object of the present disclosure to provide a control device for a machine tool that allows evacuating a tool automatically without breakage when a machining failure or the like occurs, and suppressing degradation of productivity.

### SUMMARY OF THE INVENTION

In order to achieve the above-described object, the present disclosure is a control device for a machine tool in which a tool used to machine a workpiece is mounted to a main spindle that is relatively movable with respect to the workpiece. The control device includes: a parameter preparing unit that stores a predetermined parameter regarding a control in advance; an evacuation unit that causes the tool to perform an evacuation operation from the workpiece; and a chip discharging unit that causes the tool to perform a chip discharging operation. The evacuation operation of the tool by the evacuation unit and the chip discharging operation by the chip discharging unit are performable at respective predetermined timings.

In another aspect of the disclosure, which is in the above configuration, the tool is a tap, the parameter preparing unit stores a chip discharge groove pitch of the tap and a tap rotation number set in advance, and the chip discharging unit calculates a chip discharging operation distance based on the chip discharge groove pitch and the tap rotation number, and causes the tap to perform a feed operation and a rotating operation by the discharging operation distance in a direction same as a machining direction.

In another aspect of the disclosure, which is in the above configuration, the parameter preparing unit identifies in advance an operation distance in which chips are dischargeable and evacuation is possible without damage to the tap or the workpiece, and determines the tap rotation number based on the identified result and the pitch.

Another aspect of the disclosure, which is in the above configuration, includes a machining diagnosing unit that diagnoses whether the machining of the workpiece is normal or not. The predetermined timing to perform the evacuation operation by the evacuation unit is when the machining is diagnosed as abnormal by the machining diagnosing unit.

Another aspect of the disclosure, which is in the above configuration, includes an evacuation diagnosing unit that diagnoses whether the evacuation operation by the evacuation unit is normal or not. The predetermined timing to perform the chip discharging operation by the chip discharging unit is when the evacuation diagnosing unit diagnoses the evacuation operation as abnormal and causes the evacuation operation by the evacuation unit to be canceled.

With the present disclosure, a biting of chips in a tool can be suppressed by a chip discharging operation of a chip discharging unit, and the tool can be evacuated automatically without breakage by an evacuation unit when a machining failure or the like occurs. Accordingly, degradation of productivity can be suppressed.

### BRIEF DESCRIPTION OF THE DRAWINGS

FIGS. 1A and 1B are explanatory views illustrating a change in an operational torque of a main spindle upon evacuation of a tap.

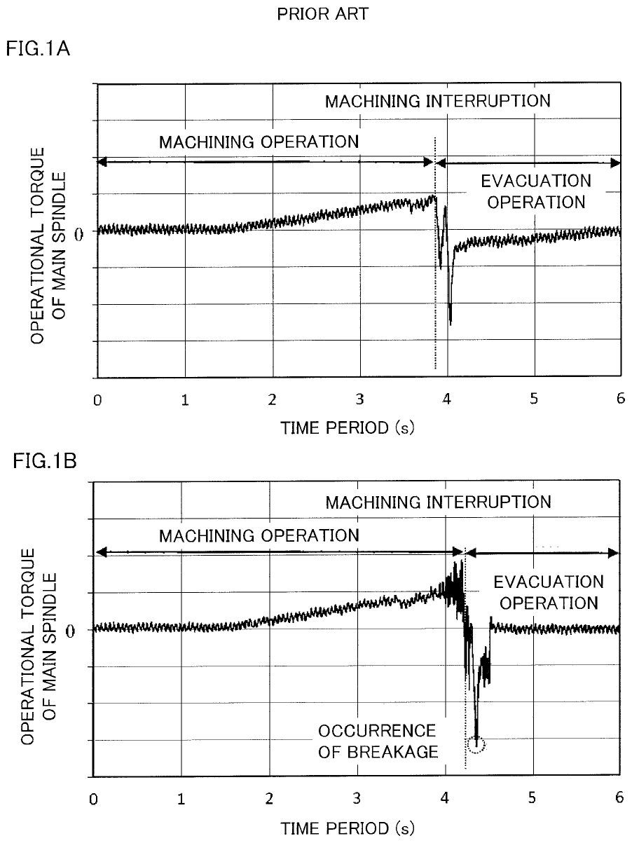

FIG. 2 is a block configuration diagram of a control device for a machine tool.

FIG. 3 is a flowchart depicting a control of the control device.

FIG. 4 is an explanatory view illustrating a change in the operational torque of the main spindle when applying the control.

### DETAILED DESCRIPTION OF THE INVENTION

The following describes embodiments of the present disclosure based on the drawings.

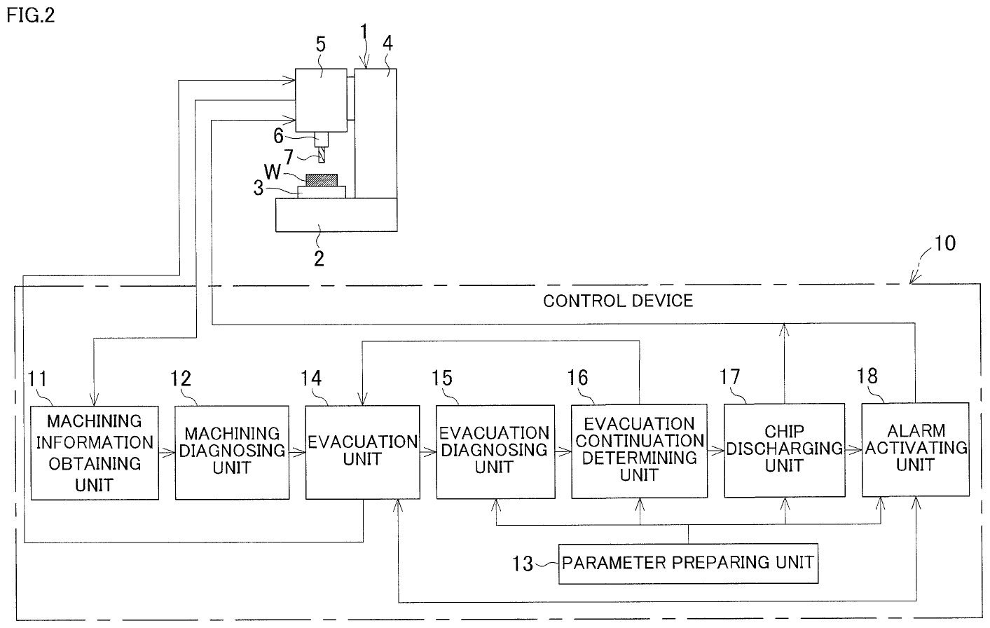

FIG. 2 is a block configuration diagram illustrating an exemplary control device of the present disclosure. A machine tool 1 is provided with a control device 10. The control device 10 may be contained in a position controller (not illustrated) of the machine tool 1.

The machine tool 1 includes a table 3 supported on a bed 2 movably in the right-left direction (Y-axis direction), a column 4 secured onto the bed 2, and a main spindle head 5 supported to the column 4 movably in the depth direction (X-axis direction) and the up-down direction (Z-axis direction). To the main spindle head 5, a main spindle 6 pointing downward is rotatably supported and a tool 7 is mountable.

The control device 10 includes a machining information obtaining unit 11, a machining diagnosing unit 12, a parameter preparing unit 13, an evacuation unit 14, an evacuation diagnosing unit 15, an evacuation continuation determining unit 16, a chip discharging unit 17, and an alarm activating unit 18.

The machining information obtaining unit 11 obtains control information and signals measured by various kinds of sensors (not illustrated) of the machine tool 1 as machining information.

The machining diagnosing unit 12 diagnoses whether the machining is normal or abnormal based on the machining information obtained by the machining information obtaining unit 11.

In the parameter preparing unit 13, parameters used for the control of the present disclosure are input or calculated, and the values are stored.

The evacuation unit 14 commands the machine tool 1 to perform the evacuation operation of causing the tool 7 to evacuate from a workpiece W when a failure is detected by the machining diagnosing unit 12.

The evacuation diagnosing unit 15 compares a breaking torque threshold value calculated based on values set by the parameter preparing unit 13 with the machining information, diagnoses whether the evacuation operation is normal or abnormal, and outputs the diagnostic result to the evacuation continuation determining unit 16.

In a case where the diagnostic result of the evacuation diagnosing unit 15 is normal, the evacuation continuation determining unit 16 commands the evacuation unit 14 to continue the evacuation operation, and in a case where the diagnostic result is abnormal, the evacuation continuation determining unit 16 commands the evacuation unit 14 to cancel the evacuation operation and commands the chip discharging unit 17 to perform the chip discharging operation of discharging chips.

The chip discharging unit 17 commands the machine tool 1 to perform the chip discharging operation of performing a feed and rotating operation of the tool 7 by a discharging operation distance calculated using set values of the parameter preparing unit 13.

The alarm activating unit 18 counts two operations of the evacuation operation and the chip discharging operation as one set, and compares the counted number of sets with a set number threshold value as a value set by the parameter preparing unit 13 to determine whether to cancel the operation and activate the alarm, or continue the evacuation operation.

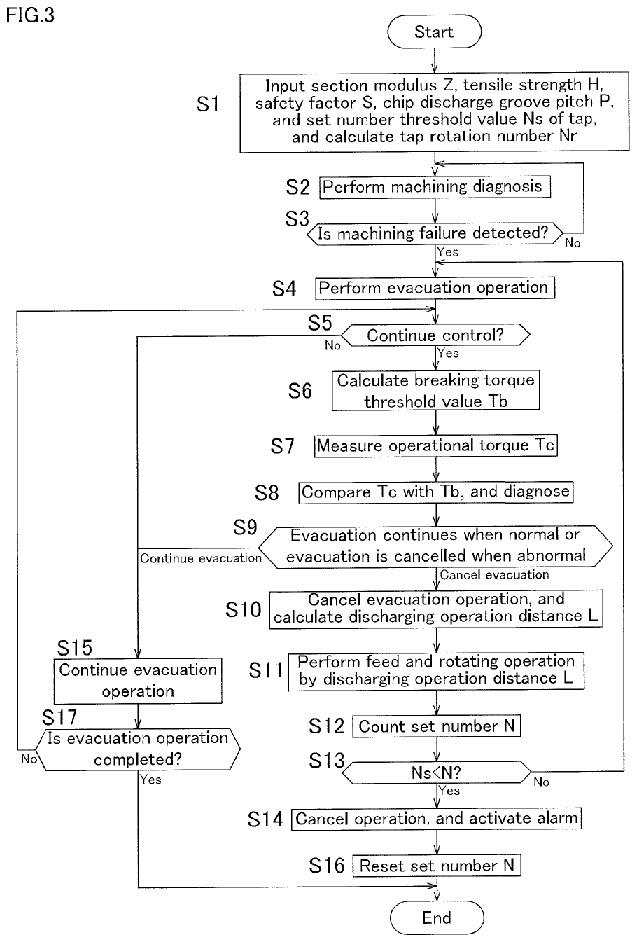

The following describes details of the control of the control device 10 based on a flowchart of FIG. 3.

In FIG. 3, Step (simply noted as “S” in the following) 1 is performed by the parameter preparing unit 13, S2 and S3 are performed by the machining diagnosing unit 12, S4, S15, and S17 are performed by the evacuation unit 14, S5, S6, and S8 are performed by the evacuation diagnosing unit 15, S7 is performed by the machining information obtaining unit 11, S9 is performed by the evacuation continuation determining unit 16, S10 and S11 are performed by the chip discharging unit 17 and the evacuation unit 14, and S12 to S14, and S16 is performed by the alarm activating unit 18.

First, in S1, a section modulus Z, a tensile strength H, a safety factor S, a chip discharge groove pitch P, and a set number threshold value Ns of the tap as the tool 7, are input and stored. A tap rotation number Nr is obtained such that an operation distance is identified by confirming in advance to be capable of discharging the chips and performing the evacuation without causing damage to the tap or the workpiece W, and the identified result is divided by the chip discharge groove pitch P. The obtained tap rotation number Nr is stored.

In S2, a machining diagnosis is performed, and in a case where a machining failure is not detected in the determination of S3, the machining diagnosis is continued in S2, and in a case where a machining failure is detected, the evacuation operation of removing the tool 7 from the workpiece W is performed in S4.

In S5, it is determined whether to continue the control, and in a case where the control is not to be continued, the evacuation operation is continued in S15, and it is determined whether the evacuation operation is completed in S17. In a case where the evacuation operation is completed, the control is terminated, and in a case where the evacuation operation is not completed, the process returns to S5. In a case where the control is continued in S5, the process proceeds to S6.

In S6, the breaking torque threshold value Tb is calculated based on the section modulus Z, the tensile strength H, and the safety factor S of the tap using the following formula (1).

Tb=2ZH/S (1)

In S7, an operational torque Tc of the main spindle 6 during the evacuation operation is measured, and in S8, the operational torque Tc and the breaking torque threshold value Tb are compared. In a case where the operational torque Tc is smaller than the breaking torque threshold value Tb, the evacuation operation is output as normal, and in a case where the operational torque Tc is larger than the breaking torque threshold value Tb, the evacuation operation is output as abnormal in S9. In S9, in a case where the evacuation operation is normal, the evacuation operation is determined to be continued, and the evacuation operation is continued in S15. In a case where the evacuation operation is abnormal, the evacuation operation is determined to be canceled, and the evacuation operation is canceled in S10. A discharging operation distance L is calculated using the following formula (2).

L=PNr (2)

In S11, a chip discharging operation of performing a feed and rotating operation of the tap by the discharging operation distance L is performed. The main spindle rotation speed or the feed speed of the chip discharging operation is not limited in any sense, and in the example, a condition similar to the machining operation is employed.

In S12, a set number N is counted with the two operations of the evacuation operation and the chip discharging operation assumed as one set. In S13, the set number N and the set number threshold value Ns are compared. As the set number threshold value Ns, with the two operations of the evacuation operation and the chip discharging operation assumed as one set, a set number that does not cause any damage on an operation shaft of the machine is confirmed in advance, and the confirmed value is used.

In the determination of S13, in a case where the set number N is smaller than the set number threshold value Ns (No in S13), the evacuation operation is continued in S4. In a case where the set number N is larger than the set number threshold value Ns (Yes in S13), the operation is canceled in S14, the alarm is activated, the set number N is reset in S16, and the process is terminated.

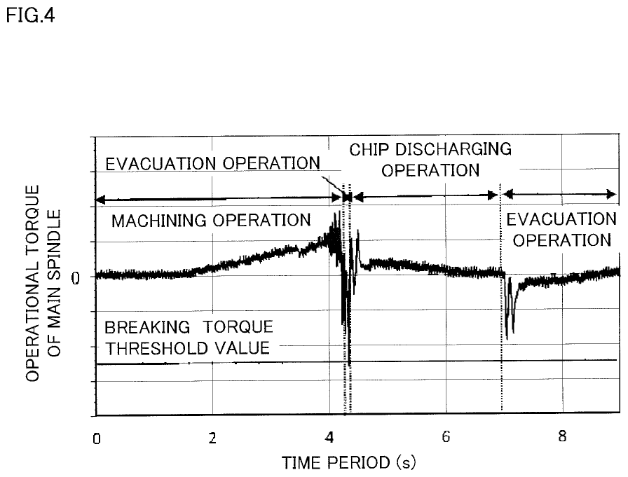

FIG. 4 illustrates a change in the operational torque of the main spindle 6 when applying the control in the present embodiment. The following is found. After a machining failure is diagnosed, the operational torque during the evacuation operation is monitored with reference to the breaking torque threshold value. The chip discharging operation is performed in a case where the operational torque exceeds the breaking torque threshold value, and the evacuation operation again is performed while the operational torque does not exceed the breaking torque threshold value, and the tap is able to be evacuated from the workpiece without breakage.

Thus, the control device 10 of the machine tool 1 in the above-described embodiment includes the parameter preparing unit 13 in which parameters regarding the control are stored in advance, the evacuation unit 14 that causes the tool 7 to perform the evacuation operation from the workpiece W, and the chip discharging unit 17 that causes the tool 7 to perform the chip discharging operation. At a timing when a machining failure is detected, the evacuation operation of the tool 7 by the evacuation unit 14 is performable, and at a timing when the evacuation operation is canceled, the chip discharging operation by the chip discharging unit 17 is performable.

With the configuration, a biting of chips in the tool 7 is suppressed by the chip discharging operation of the chip discharging unit 17, and the tool 7 can be automatically evacuated without breakage by the evacuation unit 14 when a machining failure occurs. Thus, a degradation of productivity can be suppressed.

The following describes modification examples of the present disclosure.

While in the above-described embodiment the evacuation operation by the evacuation unit is performed when a machining failure has occurred, the evacuation operation is not limited to when a machining failure occurs. The present disclosure is also applicable to a case where the evacuation operation is performed to avoid collision and the like during an ordinary machining.

The chip discharging operation by the chip discharging unit may be performed when extracting a tap that has finished an ordinary machining from the screw hole and the like and it is not limited to the timing at which the evacuation operation is canceled.

In the above-described configuration, the evacuation continuation determining unit that determines whether to continue the evacuation operation is provided together with the evacuation diagnosing unit. However, the evacuation continuation determining unit may be omitted, and the evacuation operation may be canceled based on an abnormality diagnosis in the evacuation operation by the evacuation diagnosing unit. The evacuation continuation determination process may also be performed by the evacuation diagnosing unit.

The machining diagnosing unit may employ a method of comparing the machining information with the threshold value set in advance to diagnose whether the machining is normal or abnormal, or using a mathematical model that has learned the machining information by a machine learning to diagnose whether the machining is normal or abnormal.

Besides, the machine tool is not limited to the above-described configuration. The tool is not limited to the tap, either.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A control device for a machine tool in which a tool used to machine a workpiece is mounted to a main spindle that is relatively movable with respect to the workpiece, the control device comprising:
a parameter preparing unit that stores a predetermined parameter regarding a control in advance;
an evacuation unit that causes the tool to perform an evacuation operation from the workpiece; and
a chip discharging unit that causes the tool to perform a chip discharging operation, wherein
the evacuation operation of the tool by the evacuation unit and the chip discharging operation by the chip discharging unit are performable at respective predetermined timings.

2. The control device for the machine tool according to claim 1, wherein
the tool is a tap,
the parameter preparing unit stores a chip discharge groove pitch of the tap and a tap rotation number set in advance, and
the chip discharging unit calculates a chip discharging operation distance based on the chip discharge groove pitch and the tap rotation number, and causes the tap to perform a feed operation and a rotating operation by the discharging operation distance in a direction same as a machining direction.

3. The control device for the machine tool according to claim 2, wherein
the parameter preparing unit identifies in advance an operation distance in which chips are dischargeable and evacuation is possible without damage to the tap or the workpiece, and determines the tap rotation number based on the identified result and the pitch.

4. The control device for the machine tool according to claim 1, further comprising
a machining diagnosing unit that diagnoses whether the machining of the workpiece is normal or not, wherein
the predetermined timing to perform the evacuation operation by the evacuation unit is when the machining is diagnosed as abnormal by the machining diagnosing unit.

5. The control device for the machine tool according to claim 1, comprising
an evacuation diagnosing unit that diagnoses whether the evacuation operation by the evacuation unit is normal or not, wherein
the predetermined timing to perform the chip discharging operation by the chip discharging unit is when the evacuation diagnosing unit diagnoses the evacuation operation as abnormal and causes the evacuation operation by the evacuation unit to be canceled.
